(19) United States
(12) Patent Application Publication
(10) Pub. No.: US 2008/0172311 A1
(43) Pub. Date: Jul. 17, 2008

(54) MOBILE WORKFORCE MANAGEMENT APPARATUS AND METHOD

(75) Inventor: Thomas Stephen Curran, Port Isabel, TX (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Marlin Financial Services, Inc., Aliso Viejo, CA (US)

(21) Appl. No.: 11/623,271

(22) Filed: Jan. 15, 2007

(51) Int. Cl. G06Q 30/00; H04Q 5/22

(52) U.S. Cl. 705/32; 340/10.1

(57) ABSTRACT

A handheld unit and an associated network and method are provided for tracking the worksite information for a plurality of workers assigned to various worksites and electronically distributing payroll to those workers that opt to participate in a stored value card program. In order to track the worksite information for each worker, a foreman uses a handheld unit to collect worker identification, time, pay scale, work assignment, and work volume information for subsequent transfer to a central processing server capable of accumulating the worksite information from a plurality of re-deployable handheld units. Preferably, the handheld unit is a personal digital assistant (PDA) type device that communicates via a cellular network. In an embodiment, the central processing server accumulates the worksite information in a database for subsequent reporting and analysis and forwards the pay information to a payroll processing server for payroll distribution via an optionally issued stored value card.

### FIELD OF THE INVENTION

This invention relates generally to the field of workforce management and more specifically to the field of worker and work product tracking, workforce billing and payroll distribution.

### BACKGROUND OF THE INVENTION

The modern economic paradigm involves a wide variety of work environments and locations, which often necessitate a flexible workforce that is able to adapt to frequent changes in work tasks and locales. The agricultural and construction industries, for example, are similarly affected by seasonal and workflow changes that require shifting the workforce between multiple worksites and task assignments.

In the case of agricultural crop processing, including, but not limited to, planting, harvesting, packing, and maintenance, the modern trend is to hire seasonal workers that frequently move from one ranch to another as various crops need to be harvested and processed throughout the season. Such mobility of the workforce means that a given worker may work on product owned by several different producers. This trend has resulted in creation of a mobile workforce that often includes migrant workers, which travel between various parts of the country in search of temporary work with differing agricultural producers. Among the chief concerns associated with agricultural crop processing are the health issues associated with cross contamination of crops between ranches or lots on the same ranch. The very nature of the mobile workforce environment, however, involves workers that travel from worksite to worksite, thereby increasing the chances of cross contamination, unless their previous work assignments to contaminated ranch lots are timely flagged.

Another reality of the mobile worker environment is the fact that large numbers of migrant workers typically do not have permanent addresses and, therefore, are not able to open bank accounts, possess credit cards, etc. Therefore, the unbanked population of mobile workers is forced to pay check cashing fees after every pay period, which further reduces the take-home portion of their pay. In addition, the mobile workforce is limited in its ability to rent cars, stay at hotels, etc.

Due to the characteristics of the mobile workforce, employers are faced with significant difficulties in managing the workforce. A given worker may receive pay from diverse employers for work performed at different locations on different product. The separate employers find it difficult to process pay information for the variety of workers and maintain sufficient records of which workers work on which crops. Furthermore, the workers experience difficulty in receiving their pay, especially if they change locations and providers.

In different circumstances and for different applications, others have addressed different problems, but they have failed to recognize and solve many of the problems in the mobile workforce environment and divergent employers. For example, U.S. Pat. No. 6,764,013 and related U.S. application Ser. No. 10/894,498 disclose a terminal that may be used by an employer to permit employees to punch in and out of work at a given location (e.g., a retail store location or office building) for a single employer. The patent and the related application state that the terminal also may provide work assignments and permit the employee to review his payroll details, print pay stubs, and execute financial transactions. The patent and the related application state that, in one embodiment, the terminal may be wirelessly connected to a payroll and work management center; however, to use the disclosed terminal, each employee is required to authenticate with his or her check-in either by entering a PIN number associated with a bank card that accesses the employee's bank account, or via biometric authentication. This system is impractical because employees will not share their PIN numbers for their bank accounts with their employers due to security concerns and because performance of financial transactions and printing of pay stubs is not suited for fast-paced field applications in a mobile workforce environment.

Consequently, there is still an unanswered need for a reliable system capable of electronically managing and tracking a mobile workforce which may work on divergent projects for divergent employers, while still providing cost-effective payroll distribution for the unbanked mobile worker population.

### BRIEF SUMMARY OF THE EMBODIMENTS

Embodiments of the invention may be used to provide a handheld unit, as well as an associated network and method, for tracking worksite information for a plurality of workers at various worksites and electronically distributing payroll to those workers that opt to participate in a stored value card program. Alternatively, the payroll funds may be distributed via direct deposit or printed paycheck. In one embodiment, in order to track the worksite information associated with each worker, the supervisor or foreman uses a handheld unit to collect worker identification, time, pay scale, work assignment, and work volume information for subsequent transfer to a central processing server that is capable of accumulating the collected worksite information from a plurality of handheld units. Preferably, the handheld unit is a personal digital assistant (PDA) type device that communicates with the central processing server via a cellular network. In an embodiment, a plurality of handheld units establish a mobile network with the central processing server such that the mobile units provide mobile nodes intermittently connected to the central node. Alternatively, at least some of the handheld units may communicate with the central processing server via a fixed cradle that networks with the central processing server. The central processing server may accumulate the worksite information in a database for subsequent reporting and analysis and forward pay information to a payroll processing server for payroll distribution via an optionally issued stored value card or another means.

In one aspect of the invention, a distributed network is provided for tracking and communicating agricultural crop processing information and providing compensation to workers at distinct worksites, such distributed network comprising a central processing server including a memory, a processor, and a communication portal, said central processing server providing a central node of said distributed network for handling agricultural crop processing information and compensation information specific to at least one worker, said central processing server including a database comprising fields specifying agricultural crop processing information including worksite information, task information for specific types of tasks, and a unique number associated with the at least one worker, said unique number providing identification information for the at least one worker, a plurality of handheld units including a memory, a processor, and a communication portal, and providing mobile nodes of said distributed network, said mobile nodes being capable of operating at various distinct worksites and handling various workers, said handheld units having a communication portal for receiving and storing within said memory said agricultural crop processing information including worksite information, the unique number associated with the at least one worker, and the task information for specific types of tasks, wherein the plurality of handheld units receive at least some of the worksite information via a worksite information transfer interface, said plurality of handheld units capable of being re-deployed at alternative worksites to establish alternative mobile nodes, at least one communication session established by at least one of said handheld units to generate a mobile node with said central node provided by said central processing server, said mobile node communicating to said central node, through the communication portal of said central processing server, the agricultural crop processing information including worksite information, the identification information for the at least one worker, and the task information for specific types of tasks, wherein said communication session is capable of being established wirelessly, said central processing server accumulating said worksite information in the database, including the agricultural crop processing information, the identification information for at least one worker, and the task information for specific types of tasks, from said distributed network of mobile nodes, such information being processed to generate pay information specific to the at least one worker and billing information related to processed agricultural crops, wherein such pay information is utilized to transfer funds from a bank account to credit a stored value card provided to the at least one worker and for providing the billing information to an appropriate party associated with said worksite information.

In another aspect of the invention, a handheld unit is provided that is capable of being portably deployed at one or more remote worksites and operable by one worker for tracking and communicating worksite information associated with a first plurality of workers assigned to the one or more remote worksites, the handheld unit comprising a housing, a processor responsive to inputs via a user interface for collecting and displaying the worksite information for the first plurality of workers at the one or more remote worksites, a computer readable medium having thereon instructions for storing the collected worksite information in the handheld unit, establishing a communication session by transmitting the stored worksite information via a communication interface, and wherein the handheld unit is capable of being re-deployed at one or more alternative remote worksites for tracking and communicating the worksite information associated with a second plurality of workers assigned to the one or more alternative remote worksites.

In still another aspect of the invention, a method is provided for tracking and communicating worksite information associated with a first plurality of workers assigned to one or more remote worksites, the method comprising collecting the worksite information from the first plurality of workers via a handheld unit capable of being portably deployed at the one or more remote worksites, wherein at least some of the worksite information is collected via a worksite information transfer interface, storing the worksite information in the handheld unit, transmitting the worksite information from the handheld unit by establishing a communication session with a communication network, and wherein the handheld unit is capable of being re-deployed at one or more alternative remote worksites for tracking and communicating the worksite information associated with a second plurality of workers assigned to the one or more alternative remote worksites.

### BRIEF DESCRIPTION OF THE DRAWINGS

While the appended claims set forth the features of the present invention with particularity, the invention and its advantages are best understood from the following detailed description of embodiments taken in conjunction with the accompanying drawings, of which:

FIG. 1 is a schematic diagram illustrating a mobile workforce tracking and payroll distribution environment employing a handheld unit for communicating and tracking the worksite information, as contemplated by an embodiment of the invention;

FIG. 2 is a perspective diagram of a particular embodiment of the handheld unit of FIG. 1;

FIGS. 3-5 are diagrams illustrating embodiments of the user interface screens of the handheld unit of FIG. 1;

FIG. 6 is a diagram illustrating a job card screen produced by a central processing server from the worksite data received from one or more handheld units of FIG. 1, as contemplated by an embodiment of the invention;

FIG. 7 is a diagram illustrating a report produced by a central processing server of FIG. 1, as contemplated by an embodiment of the invention; and

FIG. 8 is flowchart of a method for tracking and communicating the worksite information, as contemplated by an embodiment of the invention.

### DETAILED DESCRIPTION OF EMBODIMENTS

The following examples further illustrate the invention but, of course, should not be construed as in any way limiting its scope.

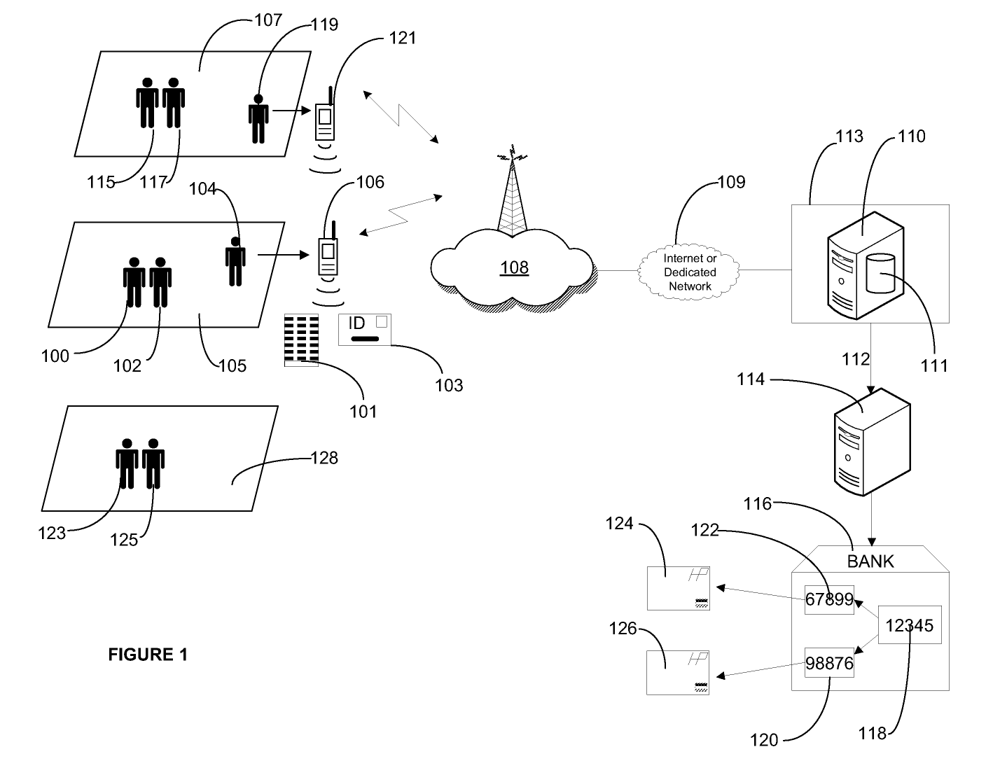

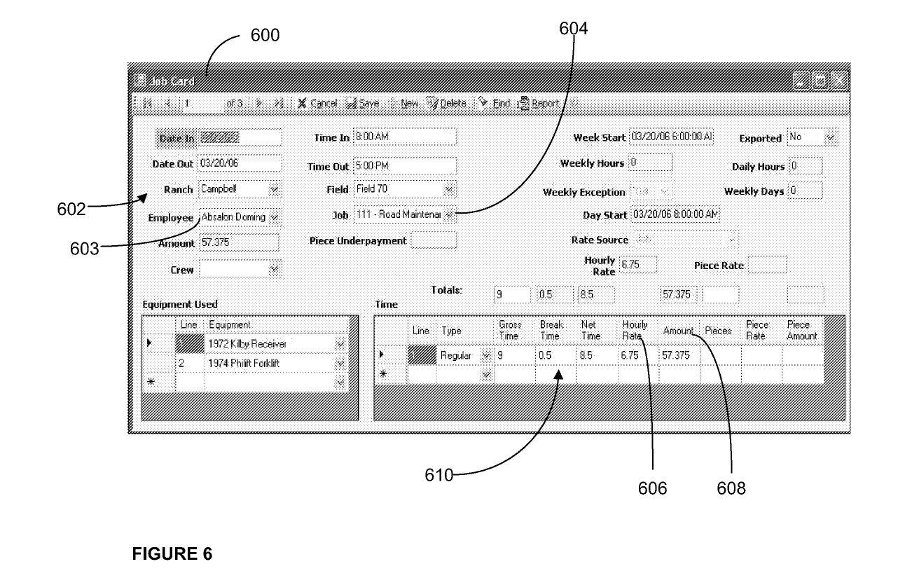

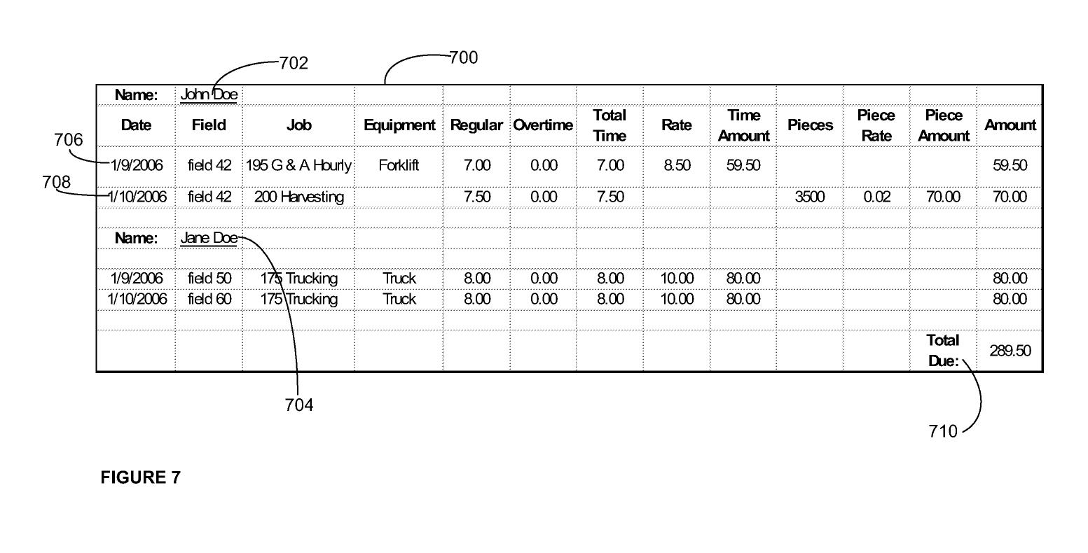

Turning to FIG. 1, an implementation of a system contemplated by an embodiment of the invention is shown with reference to workforce management including worker and work product tracking, workforce billing and payroll distribution. In the illustrated embodiment, a plurality of foremen or supervisors 104, 119 oversee one or more workers 100, 102, 115, 117 as they perform various tasks at distinct worksites 105, 107. Preferably, the tasks performed by the workers 100, 102, 115, 117 include a plurality of field tasks associated with crop processing at the worksites 105, 107. Other embodiments include performing different types of work, including other agricultural, road maintenance, or construction duties, etc. In order to track the worksite information associated with each of the workers 100, 102, 115, 117 assigned to their respective worksites 105, 107, each supervisor 104, 119 may use a handheld unit 106, 121 to collect worker identification, time, pay scale, work assignment, and work volume information for subsequent transfer to the central processing server 110. In this embodiment, the central processing server 110 is a computer, located at the processing office 113, and having suitable processor and memory capabilities for handling and accumulating the collected worksite information from a plurality of handheld units 106, 121. Preferably, the central processing server 110 accumulates the worksite information in a database 111 for subsequent reporting and analysis, as discussed in more detail below in connection with FIGS. 6 and 7.

For agricultural tasks, the workers 100, 102, 115, 117 are organized in crews, where each worker is assigned a specific task within various parts of their corresponding worksite 105, 107. Typically, the worksites 105, 107 are located at a given grower's ranch and correspond to a specific crop. For example, with respect to the worksite 105, on a given day, the supervisor 104 may assign the workers 100, 102 to crew 6, which works in field 92, lot 5, of the “Wray” ranch, where the worker 100 is assigned to perform a task of picking the crop, while the worker 102 is assigned a task of loading the crop containers using the forklift equipment. Therefore, in this case, the work assignment information associated with each worker 100, 102 includes assigned crew, ranch, field, lot/block, task, as well as corresponding crop and equipment information. As the agricultural crop processing season progresses and/or the field conditions change, some or all of the workers 100, 102 may be assigned to different ranches or fields where a different set of tasks may need to be performed.

Similarly, when the need arises, any of the handheld units 106, 121, which the foremen 104, 119 use to collect the information relevant to the worksites 105, 107, may be re-deployed at an alternative worksite 128 in order to collect the worksite information relevant to another set of workers 123, 125. Therefore, the handheld unit 106, 121 is a portable device having one or more interfaces for collecting the worksite information pertaining to the workers 100, 102, 115, 117, and 123, 125. In this embodiment, the handheld unit 106, 121 is a personal digital assistant (PDA) type device that includes a barcode scanner, a keypad, and a touch screen for collecting the worksite information. In other embodiments, the handheld unit 106, 121 is a laptop computer or another portable device.

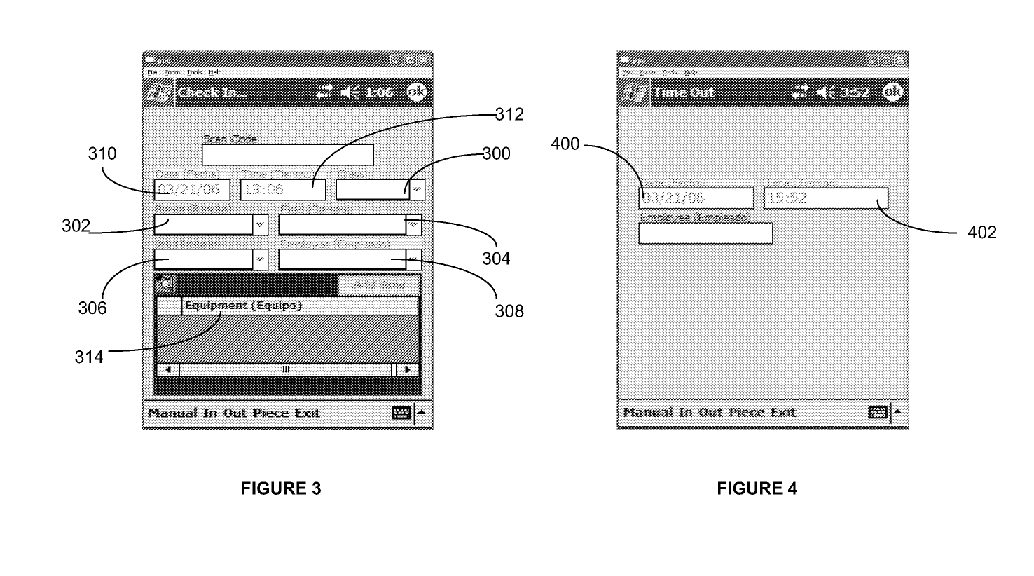

Upon arrival to the worksite 105, 107, each foreman 104, 119 supplies a combination of inputs to their respective handheld unit 106, 121 to collect the information pertaining to the workers 100, 102, 115, 117 and the current worksite 105, 107. To facilitate the collection process, the foremen 104, 119 use an information transfer interface to scan at least some of the worksite information into the handheld unit 106, 121. To this end, when the handheld unit 106, 121 includes a barcode scanner, each foreman 104, 119 carries a list of barcodes 101 that includes the ranch, field, lot/block, and crop commodity pertaining to the current worksite 105, 107. Upon arrival to the worksite 105, 107, each foreman 104, 119 initiates the information transfer to their handheld unit 106, 121 by scanning this information from the list of barcodes corresponding to a given worksite 105, 107. To identify each worker, the foremen 104, 119 scan each worker's identification badge 103 having a unique number for the worker. Preferably, the worker identification number is encoded into a barcode strip located on each worker's identification badge 103. Other embodiments include using an RFID scanner in the handheld unit 106, 121 to scan the RFID tags identifying the workers 100, 102, 115, 117, as well as the ranch, field, lot/block, and crop commodity specific to the corresponding worksite 105, 107. As illustrated in more detail in FIGS. 3-5 below, each foreman 104, 119 inputs additional worksite information by using selectable lists or drop down menus preloaded into the handheld unit 106, 121 and accessible via a touch screen or keypad, for example.

During lunch breaks or at the end of the workday, the foremen 104, 119 clock out some or all workers 100, 102, 115, 117 and review or edit the worksite information prior to transmitting it to the central processing server 110. To transmit the collected worksite information to the central processing server 110, each handheld unit 106, 121 independently initiates a communication session with a wireless network 108, thereby providing a mobile node connection to the central processing server, or central node, 110. Therefore, when a plurality of handheld units 106, 121 intermittently and independently communicate with the central node 110, a distributed network of mobile nodes is created. Preferably, the network 108 is a wireless wide area network (WWAN) complying with a cellular network access technology that is capable of providing data communication, such as CDMA, GSM, GPRS, EDGE, CDMA 2000, or UMTS based network. Other embodiments include using a WiMAX or Wi-Fi based network 108 to communicate with the central processing server or node 110. The network 108, in turn, relays the worksite data to the central processing server 110 via the network 109. In an embodiment, the network 109 is the public Internet. Alternatively, the network 109 comprises a private network of dedicated trunk lines connecting the wireless network 108 and the processing office 113. In yet another embodiment, at least some of the handheld units 106, 121 may communicate with the central processing server 110 via a fixed cradle that networks with the central processing server 110, such as via a local LAN network.

Upon receiving the transmitted worksite information from one or more handheld units 106, 121, the central processing server 110 accumulates the worksite information from the plurality of handheld units 106, 121 in a database 111. In an embodiment, the central processing server 110 performs transmission error detection prior to sending out a confirmation of a successful download to the handheld unit transmitting the worksite information, such as by checking for receipt of an end-of-file (EOT) identifier.

Periodically, the central processing server 110 processes the accumulated worksite information to produce billing and management reports. In embodiments where the workers 100, 102, 115, 117 are outsourced to various worksites, the billing reports are used to bill the entities receiving the benefit of the labor of the workers 100, 102, 115, 117. The management reports, in turn, allow detailed resource, revenue, and other types of analysis for various worksites and time periods. In addition to providing the reporting functionality, the central processing server 110 is also capable of editing the worksite information, such as to adjust the clock in and clock out times or fix any manual data entry errors, etc. The central processing server 110 also serves as a central repository of common worksite information that is preloaded onto the handheld units 106, 121 and used during worksite data collection in the field. For example, the database 111 of the server 110 includes worker identification, ranch, field, lot/block, task type, as well as equipment information. To this end, the central processing server 110 is capable updating multiple handheld units 106, 121, via the network 108, when changes to some or all of the worksite information need to be made or to initialize the handheld units 106, 121 with common information, such as when new worker identification codes and ranches are added to the system. In an embodiment, when new worker's identification has not yet been created at the central processing server 110 for distribution to the plurality of handheld units 106, 121, each foreman 104, 119 is able to issue temporary worker identification in the field via his corresponding handheld unit 106, 121.

Additionally, the central processing server 110 processes the accumulated worksite data to calculate pay information, including overtime, associated with each worker 100, 102, 115, 117 in order to forward this data to a payroll processing server 114 for payroll distribution and processing. In an embodiment, the central processing server 110 includes the calculated pay information, such as total hours, pay scale and rate, and gross pay before deductions, in a file or report 112, which it forwards to a payroll processing server 114. The payroll processing server 114 is typically a computer having memory and processing capabilities suitable for handling the pay information to calculate the net pay, including associated deductions, due each worker 100, 102, 115, 117 and to forward the payroll instructions to the bank 116 for distribution of funds. In one embodiment, the payroll processing server 114 runs known accounting software, such as the Famous accounting software manufactured by Famous Software, LLC, to handle the payroll information. In embodiments, the payroll processing server 114 may be either collocated with or located remotely from the central processing server 110, such as when the servers 110 and 114 belong to same or different entities respectively. In still other embodiments, the central processing server 110 also performs the functions of the payroll processing server 114 such that a single server provides all of the needed functionality.

Preferably, the payroll distribution is accomplished via crediting the stored value cards 124, 126 issued to at least some of the workers 100, 102, 115, 117 that opt to participate in such program. The stored value cards may also represent bank accounts owned by the individual workers. Where the workers utilize stored value cards and do not possess their own bank accounts, this allows those workers 100, 102, 115, 117 that opt to receive their pay via stored value cards 124, 126 and forego the necessity of having a bank account to avoid paying the check cashing fees associated with typical bankless transactions. To eliminate the need for worker-owned bank accounts, the payroll processing server 114 issues instructions initiating a transfer of funds, corresponding to each participating worker's net pay, from an employer master account 118 into corresponding sub-accounts 120, 122. The sub-accounts 120, 122 are also employer owned accounts, each associated with a corresponding stored value card 124, 126. Thus, upon the transfer of the amounts due each worker 100, 102 or 115, 117 into the sub-accounts 120, 122, the stored value cards 124, 126 are credited and the funds become available. Preferably, the stored value cards 124, 126 are compatible with major financial brands and corresponding network systems, such as VISA, MASTERCARD, CIRRUS, and the like, thereby allowing their use as debit or credit cards by being acceptable at all consumer establishments accepting payments processed via these systems and networks.

One example of use of the distributed network of re-deployable mobile nodes 106, 121, including the central processing server 110 and payroll processing server 114, may be by a wine grower during the grape harvesting season. The distributed network allows tracking of workers, work product, workforce billing and payroll distribution, as well as tracking and identification of tainted crops, in a context of a brief harvesting season, which typically lasts only a few short weeks but involves significant logistical concerns. For example, typical wine country may span hundreds of square miles and may include hundreds of separate fields requiring hundreds or thousands of workers that migrate between fields, which in some cases are associated with different growers. Thus, the described system and distributed network may be used to significantly reduce the time and cost associated with tracking the mobile workers and their work product within the time span of a short harvesting season. Additionally, workers that worked on tainted fields may be quickly identified to prevent cross contamination between fields and growers. Furthermore, the associated reduction in manual processing and elimination of collection of paper time cards, achieves additional efficiencies by way of a reduction of the field supervisory and central office processing staff. Since some or all of the seasonal crop harvesting workers 100, 102, 115, 117 may be temporary, the system provides a flexible way of distributing payroll by optionally allowing some of the workers to participate in a stored value card program without requiring the participating workers to share their private PIN information associated with the stored value card 124, 126 or to have their own bank accounts. This further allows the participating workers to change the stored value card PIN number at will.

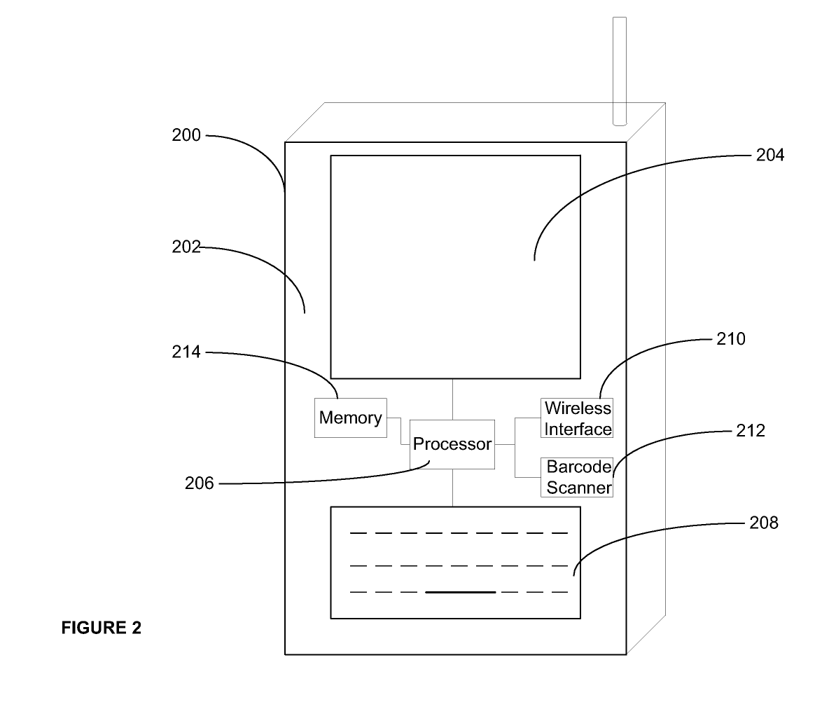

Turning to FIG. 2, an embodiment of the handheld unit 200 is shown. Preferably, the handheld unit 200 is a personal digital assistant (PDA) type device. In such an embodiment, a touch screen display 204 is disposed within the housing 202 for providing user interface functionality and conveying user inputs to the processor 206 in order to collect the worksite information. Similarly, the keypad 208, along with a barcode scanner 212, provides additional inputs to the processor 206. The processor 206, in turn, issues instructions to write the newly collected worksite information to the internal memory 214 and transmit the collected information to the central processing server via a wireless communication interface 210. Preferably, the communication interface 210 is a compatible with cellular network access technology capable of relaying data transmissions, such as CDMA, GSM, GPRS, EDGE, CDMA 2000, or UMTS access standards. In other embodiments, the communication interface 210 also includes wireless local area network (WLAN) access capability, such as via a Wi-Fi based interface, and/or a wireline modem for a wired data connection to the central processing server 110 (FIG. 1). When the central processing sever 110 sends out an update to the commonly preloaded portion of the worksite information in each of the handheld units 200, the communication interface 210 receives the update and forwards this information to the processor 206 for updating the contents of the memory 214. An exemplary embodiment of the handheld unit 200 includes model MC 70 Enterprise Digital Assistant (EDA) manufactured by Symbol Technologies Inc. and incorporating mobile phone, PDA, computer, scanner and imager capabilities in a single field-deployable unit.

Turning to FIGS. 3-5, embodiments of the user interface screens of the handheld unit are shown. Specifically, FIGS. 3-5 illustrate interface screens of the handheld unit used for entering the time, crew, ranch, field, job/task, worker identification, as well as the amount of picked crop commodities and equipment type information at the worksite 105. In FIG. 3, the foreman 104, 119 uses his corresponding handheld unit 106, 121 to select a crew name or number from a drop down menu 300 comprising a preloaded list of available crew identifiers. Similarly, the foreman 104, 119 scans a list of barcodes corresponding to the current ranch/grower and field information to populate the fields 302, 304. After assigning a task from a list of available jobs types 306, the foreman 104, 119 scans a given worker's identification badge to populate the employee field 308. Additional interface screens may be used to scan in the barcodes corresponding to the crop commodity associated with the worksite 105, 107. After scanning an employee ID badge for a given worker, the date and time fields 310, 312 are automatically populated with the current time and date information to represent the clock in time for such worker. The foreman 104, 119 also uses the barcode list 101 to scan the barcode corresponding to the assigned equipment and populate the field 314 and, in this embodiment, uses additional screens to select the pay scale corresponding to the task assigned to the clocked in employee. In order to speed up the clocking in process, the ranch, field, job, and crew information is optionally carried over when the foreman 104, 119 needs to clock in the next worker.

As illustrated in FIG. 4, at the end of the shift or during breaks the foreman 104, 119 repeats the barcode scan from the identification badge of a clocked in employee in order to capture the clock out date and time in the fields 400, 402. Alternatively, the foreman 104, 119 may manually clock out the entire crew at the end of the day or during common breaks.

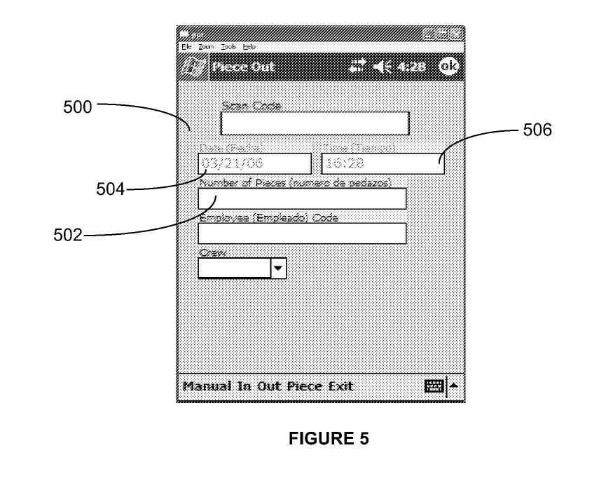

Referring to FIG. 5, when a given employee is assigned a crop picking task, the foreman 104, 119 uses the interface screen 500 to enter the total number of picked pieces into the field 502 prior to clocking out the worker by scanning the worker's identification badge. When the foreman 104, 119 scans an individual worker's ID badge, the date and time fields 504, 506 are populated and may serve as the clock out record. Alternatively, when the picked pieces information is associated with an entire crew, the foreman 104, 119 still needs to complete the clock out process of FIG. 4 for each individual worker within the crew prior to transmitting the collected worksite information to the central processing server.

FIG. 6 illustrates a job card screen produced by the central processing server from the worksite data received from one or more handheld units 106, 121. As seen in FIG. 6, the job card interface 600 of the central processing server represents information related to a completed job 604 by a worker 603 and correlates the collected worksite information 602 with the pay scale data 606 and the time record data 610 to calculate the pay information 608 for subsequent transmission of job card data to the payroll processing server. When the central processing server accumulates information associated with multiple tasks or jobs performed by the worker 603, each set of job information is batch processed to create multiple job cards 600 for the worker 603. In an outsourcing scenario, to provide billing information associated with the job card data, the central processing server is capable of generating various billing reports. For example, FIG. 7 illustrates a report 700 representing the total amount of outsourcing revenue 710 due based on the work performed by workers 702, 704 on the same ranch. When the job card data associated with workers 702, 704 includes various jobs corresponding to different foremen and/or worksite assignments, the report 700, generated by the central processing server 110, accumulates the various assignments for each worker into a single report covering the desired date span 706, 708.

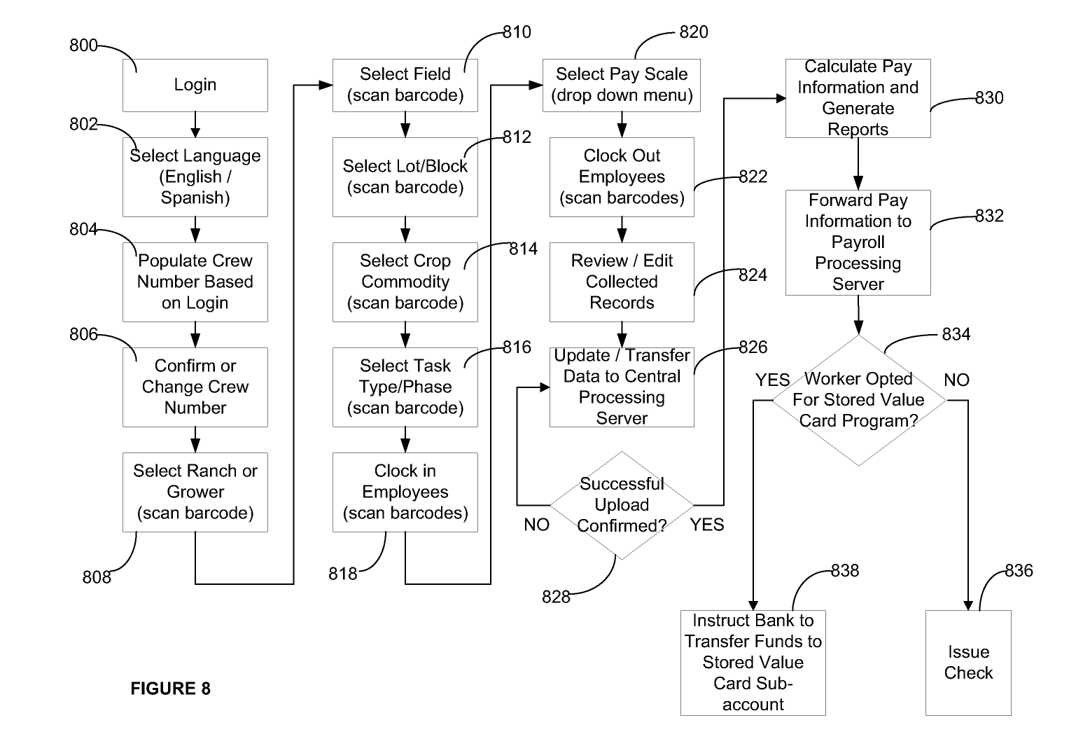

Turning to FIG. 8, an embodiment of a method for tracking and communicating worksite information is shown. In steps 800, 802, upon arrival to the worksite, the foreman logs into the handheld unit 106 via a unique password and selects the interface language. In this embodiment, the handheld unit 106 allows a choice of either English or Spanish menus. In step 804, the crew number is automatically populated based on foreman's login, for example based on a last crew number assignment used by the foreman 104. To this end, the foreman 104 either confirms or changes the preselected crew number, step 806, and scans the list of barcodes to input the current ranch or grower into the handheld unit 106. Next, in steps 810-814, the foreman 104 uses the handheld unit 106 to scan the list of barcodes for the field, lot/block, and crop commodity corresponding to the current worksite. In step 816, after assigning a task type or phase via a drop down list, the foreman 104 begins to clock in each employee or worker by scanning the barcodes from each worker's identification badge, step 818. After scanning a given worker's identification badge, the foreman 104 selects a pay scale for each employee, such as whether an hourly or a piece rate should be used for the current shift, step 820. If the pay scale is piece rate and a given worker leaves early during the shift, the foreman 104 is prompted to input the quantity of picked pieces for that worker. In step 822, at the end of the shift, the foreman 104 clocks out each worker by scanning the worker's identification badge and, when piece rate is used, inputting the number of picked pieces into the appropriate menu screen (FIGS. 4 and 5). Alternatively, the foreman 104 may use an appropriate menu screen within the handheld unit 106 to clock out an entire crew at once.

Once the foreman 104 clocks out all workers, he or she has an opportunity to review and edit the collected worksite information, including adjusting the pay scales and time records, step 824. In step 826, when the foreman 104 selects the “update” option, the handheld unit 106 initiates a communication session with the central processing server 110, preferably via a cellular network. In step 828, if the handheld unit 106 receives a confirmation of a successful upload from the central processing server 110, the communication session is over. Otherwise, the foreman 104 re-initiates the worksite information upload process.

In step 830, the central processing server 110 calculates the pay information associated with each worker and generates the management and/or billing reports based on the accumulated worksite information from a plurality of handheld units 106, 121. For payroll distribution and processing, the central processing server 110 forwards the pay information to a payroll processing server 114 in step 832. If, in step 834, a given worker has opted to participate in a stored value program, the payroll processing server 114 instructs the bank 116 to transfer funds in the amount of net pay for such worker from an employer master account 118 into a stored value card sub-account corresponding to the worker's stored value card, step 838. Otherwise, in step 836, the worker is issued a check. In alternative embodiments where the workers have bank accounts, the stored value program can take on other forms including for example where the payroll processing server 144 may instruct direct deposit of funds to an account of the worker.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A distributed network for tracking and communicating agricultural crop processing information and providing compensation to workers at distinct worksites, such distributed network comprising:
a central processing server including a memory, a processor, and a communication portal, said central processing server providing a central node of said distributed network for handling agricultural crop processing information and compensation information specific to at least one worker, said central processing server including a database comprising fields specifying agricultural crop processing information including worksite information, task information for specific types of tasks, and a unique number associated with the at least one worker, said unique number providing identification information for the at least one worker;
a plurality of handheld units including a memory, a processor, and a communication portal, and providing mobile nodes of said distributed network, said mobile nodes being capable of operating at various distinct worksites and handling various workers, said handheld units having a communication portal for receiving and storing within said memory said agricultural crop processing information including worksite information, the unique number associated with the at least one worker, and the task information for specific types of tasks, wherein the plurality of handheld units receive at least some of the worksite information via a worksite information transfer interface, said plurality of handheld units capable of being re-deployed at alternative worksites to establish alternative mobile nodes;
at least one communication session established by at least one of said handheld units to generate a mobile node with said central node provided by said central processing server, said mobile node communicating to said central node, through the communication portal of said central processing server, the agricultural crop processing information including worksite information, the identification information for the at least one worker, and the task information for specific types of tasks, wherein said communication session is capable of being established wirelessly;
said central processing server accumulating said worksite information in the database, including the agricultural crop processing information, the identification information for at least one worker, and the task information for specific types of tasks, from said distributed network of mobile nodes, such information being processed to generate pay information specific to the at least one worker and billing information related to processed agricultural crops, wherein such pay information is utilized to transfer funds from a bank account to credit a stored value card provided to the at least one worker and for providing the billing information to an appropriate party associated with said worksite information.

2. The network of claim 1 wherein the central processing server is capable of updating at least some of the worksite information and communicating the updated worksite information to the plurality of handheld units.

3. The network of claim 1 wherein at least one of the plurality of handheld units includes one or more of a barcode scanner, an RFID scanner, a keypad, and a touch screen.

4. The network of claim 1 wherein at least one of the plurality of handheld units is a personal digital assistant (PDA) device.

5. The network of claim 1 wherein the communication session is a cellular communication session.

6. The network of claim 1 wherein the at least one worker is temporarily assigned to each of the various distinct worksites.

7. A handheld unit capable of being portably deployed at one or more remote worksites and operable by one worker for tracking and communicating worksite information associated with a first plurality of workers assigned to the one or more remote worksites, the handheld unit comprising a housing, a processor responsive to inputs via a user interface for collecting and displaying the worksite information for the first plurality of workers at the one or more remote worksites, a computer readable medium having thereon instructions for storing the collected worksite information in the handheld unit, establishing a communication session by transmitting the stored worksite information via a communication interface, and wherein the handheld unit is capable of being re-deployed at one or more alternative remote worksites for tracking and communicating the worksite information associated with a second plurality of workers assigned to the one or more alternative remote worksites.

8. The handheld unit of claim 7 wherein the worksite information comprises at least one of worker identification, work assignment, work volume, time record, and pay scale information for each worker in the first and second pluralities of workers.

9. The handheld unit of claim 8 wherein the work assignment information is an agricultural crop processing assignment, the work assignment information comprising at least one of crew identification information, crop information, ranch information, field information, lot information, task information, and equipment information.

10. The handheld unit of claim 8 wherein the handheld unit transmits the worksite information to a central processing server capable of updating the work assignment and pay scale information and communicating the updated work assignment and pay scale information to the handheld unit.

11. The handheld unit of claim 7 wherein the user interface includes one or more of a barcode scanner, an RFID scanner, a keypad, and a touch screen.

12. The handheld of claim 7 wherein the handheld unit is a personal digital assistant (PDA) device.

13. The handheld unit of claim 7 wherein the communication interface is wireless.

14. The handheld unit of claim 7 wherein the communication interface includes cellular communication.

15. The handheld unit of claim 7 wherein at least one worker is temporarily assigned to the one or more remote worksites.

16. The handheld unit of claim 10 wherein the central processing server includes a database for producing at least one of management reports and billing reports.

17. The mobile node of claim 10 wherein the central processing server forwards the worksite information to a payroll processing server for processing pay information for the first and second pluralities of workers, said pay information utilized to transfer funds from a bank account to credit a stored value card provided to at least one worker in the first and second pluralities of workers.

18. A method for tracking and communicating worksite information associated with a first plurality of workers assigned to one or more remote worksites, the method comprising:
collecting the worksite information from the first plurality of workers via a handheld unit capable of being portably deployed at the one or more remote worksites, wherein at least some of the worksite information is collected via a worksite information transfer interface;
storing the worksite information in the handheld unit;
transmitting the worksite information from the handheld unit by establishing a communication session with a communication network; and
wherein the handheld unit is capable of being re-deployed at one or more alternative remote worksites for tracking and communicating the worksite information associated with a second plurality of workers assigned to the one or more alternative remote worksites.

19. The method of claim 18 further comprising the steps of:
forwarding the worksite information for processing pay information for the first and second pluralities of workers;
providing a stored value card to at least one worker in the first and second pluralities of workers; and
utilizing said pay information to transfer funds from a bank account to credit the stored value card.

20. The method of claim 18 wherein the communication network is a cellular network.
